(19) United States
(12) Patent Application Publication
(10) Pub. No.: US 2008/0172175 A1
(43) Pub. Date: Jul. 17, 2008

(54) Funny/humorous/abusive GPS system or navigation system

(76) Inventor: Manju Chexal, Cupertino, CA (US)

Correspondence Address: Ms. MANJU CHEXAL, 10425 Imperial Avenue, Cupertino, CA, 95014, US

(21) Appl. No.: 11/653,471

(22) Filed: Jan. 16, 2007

(51) Int. Cl. G01C 21/36

(52) U.S. Cl. 701/211

(57) ABSTRACT

My invention is an added feature to the existing GPS systems or navigation systems. It can also be a stand alone GPS system as well. Currently the navigation systems politely give you directions to your desired destination. My invention will be an extra feature in voice generated directions or audio system, which if added to the existing GPS systems can be turned on or off at will. Depending on the mood of the driver or the passengers, this new feature will add a little spice in driving especially to new destinations. The system will behave like a normal human being and will be little unforgiving in case the driver has trouble following voice generated directions. The voice generated directions will be spiced up by adding funny phrases like “YOU SILLY” OR “YOU DUMMY” OR “YOU STUPID” etc. It will purely add a lot of fun and laughter in the vehicle for the driver and the passengers and driving can be a fun experience.

In ABUSIVE GPS SYSTEM, meant only for adults, any kind of language or four-letter words or phrases can be programmed in the system. This will also add a lot of spice to the driving of vehicles.

### BACKGROUND OF THE INVENTION

GPS or navigation system is a gadget which with the help of a satellite guides you when you are driving a vehicle and gets you to your desired destination. When this gadget is turned on, it can locate where you are. When the address of the destination is entered in this little, computer operated machine, the driver can either look at the street map shown on its screen or can also turn on voice (audio) guided directions in addition. These directions are usually given very politely in a woman's voice, some cases could be a man's voice too. With my invention, there will be an extra feature added to the existing GPS systems. The drivers will be able to turn on or off this feature. Funny phrases like “YOU STUPID” OR “YOU SILLY” OR “YOU DUMMY” will be added in the audio system while giving directions. The voice will gently scold or admonish the driver in case the driver was unable to follow directions. It will also appreciate the driver for being able to follow directions given by the voice. This feature can be added to all the navigation devices throughout the world and in all different languages. This kind of feature can act as a mood enhancer or mood up-lifter for drivers and passengers in a vehicle and can add a little spice to the journey.

### SUMMARY OF THE INVENTION

My invention is an added feature to the existing GPS systems or navigation systems. It can also be a stand alone GPS system as well. Currently the navigation systems politely give you directions to your desired destination. My invention will be an extra feature in voice generated directions or audio system, which if added to the existing GPS systems can be turned on or off at will. Depending on the mood of the driver or the passengers, this new feature will add a little spice in driving especially to new destinations. The system will behave like a normal human being and will be little unforgiving in case the driver has trouble following voice generated directions. The voice generated directions will be spiced up by adding funny phrases like “YOU SILLY” OR “YOU DUMMY” OR “YOU STUPID” etc. It will purely add a lot of fun and laughter in the vehicle for the driver and the passengers and driving can be a fun experience.

In ABUSIVE GPS SYSTEM, meant only for adults, any kind of language or four-letter words or phrases can be programmed in the system. This will also add a lot of spice to the driving of vehicles.

### DETAILED DESCRIPTION OF THE INVENTION

Most modern vehicles such as cars, vans, SUVS, wagons, jeeps or trucks have navigation systems to guide the driver to reach his or her desired destination. There are portable navigation systems as well, which look like a little computer with a screen and can be taken in and out of a vehicle. In the current navigation system, the driver has the option to turn on or off the audio feature or voice guided directions. When the audio is turned on, driving directions are politely given to the driver in a female or male voice. For example: If a right turn is coming up in the directions, then you will hear something like “In ¼ of a mile, coming up right turn” or “turn right after ¼ mile on (say) Camden Avenue”. In case you could not follow directions and you missed the turn, the navigation system re-assesses your location and comes up with new directions, either politely a voice will ask you to take a U-turn or give you new directions without getting irritated.

The navigation system I am proposing can be a stand-alone GPS system or can be an added feature to the existing navigation systems. This feature can be turned on or off depending on the mood of the driver. It will be called Funny GPS. In this feature, the directions to your destination are calculated as normal or usual, and the voice can start your journey by saying “LET'S SEE WHERE YOU ARE GOING TODAY” OR “OK FOLLOW ME, I'LL GET YOU THERE” OR IT COULD SAY “LISTEN CAREFULLY TO WHAT I SAY, DON'T MAKE ME REPEAT.” But if you missed to follow directions, then what you hear simply will not be polite. You will hear something like, “HEY YOU, I SEE YOU ARE NOT PAYING ATTENTION!” OR “LOOKS LIKE YOU HAVE TROUBLE TODAY FOLLOWING DIRECTIONS! BUT DON'T YOU WORRY, I'LL FIND YOU THE WAY.” And if you missed to follow directions again, it could blurt out, “YOU FOOL!” OR “YOU STUPID” OR “YOU DUMMY, YOU DID IT AGAIN!” And if you are able to follow directions as it says, then you are in for some appreciation such as “GOOD JOB!” OR “GREAT!” OR “EXCELLENT!” These are just a few examples of phrases which can be programmed in the GPS system. GPS programmers can program indefinite number of funny, unforgiving and scolding kind of words and phrases to add a little spice to the voice guided directions. This feature will use only common, daily use, not very harsh but funny phrases which can be easily used in the presence of children or family environment.

Another kind of programming can be done separately, meant purely for adults. This can be called ABUSIVE GPS SYSTEM. Instead of just simple admonishes, the voice can blurt four letter words at you. Any sort of language, four-letter words can be programmed in this on and off feature.

FUNNY/HUMOROUS/ABUSIVE GPS SYSTEM FEATURES CAN ONLY BRING A LITTLE LAUGHTER TO THE LISTENERS AND CAN MAKE THE DRIVING EXPERIENCE MORE ENJOYABLE.

1. I claim that the funny features I am proposing for the voice generated directions, can be added to the existing GPS or navigation systems world-wide. A stand-alone machine can also be built with these funny features. The spicy funny phrases as described in the detailed description of the invention can be added in hundreds of different languages for use in various countries. My invention will certainly enhance the existing navigation systems. The features I am proposing are not part of any existing GPS or navigation system at present. These features will bring into life NEW AND IMPROVED GPS SYSTEM. Listening to funny or gentle admonishes will certainly add a little spice in the life of travelers, drivers and passengers and the navigation system can act as a mood enhancer. In the ABUSIVE GPS feature, the travelers could also have fun listening to harsh admonishes or abusive phrases like four letter words.
